(19) United States
(12) Patent Application Publication
(10) Pub. No.: US 2014/0322931 A1
(43) Pub. Date: Oct. 30, 2014

(54) STRUCTURE OF PRINTED CIRCUIT BOARD OF ELECTRICAL CONNECTOR

(71) Applicant: KINNEXA, INC., Taipei City (TW)

(72) Inventor: KUAN-HSIUNG WEI, Taipei City (TW)

(73) Assignee: KINNEXA, INC., Taipei City (TW)

(21) Appl. No.: 13/945,917

(22) Filed: Jul. 19, 2013

(30) Foreign Application Priority Data
Apr. 26, 2013 (TW) 102207736

(51) Int. Cl. H01R 12/71

(52) U.S. Cl. CPC H01R 12/716
USPC 439/55

(57) ABSTRACT

A structure of a printed circuit board of an electrical connector generally includes a plurality of circuit boards, which provides a network signal transmission matching function and a plurality of coupling modules, which includes arrayed pins embedded therein. Each of the circuit boards is fixedly mounted to one side of each of the coupling modules and is electrically connected to ends of the arrayed pins and forms a channel. As such, the technical feature of the present invention that uses circuit boards to serve as bridge connection allows the circuit boards to be assembled to the coupling modules in such a way that additional wiring is not needed and connection can be established through soldering applied to the arrayed pins, thereby achieving the advantages that assembling can be carried out in an easy, fast, and time-efficient manner.

### TECHNICAL FIELD OF THE INVENTION

The present invention generally relates to an electrical connector, and more particularly to a structure of a printed circuit board of an electrical connector that shows excellent IEEE and EMI properties, has no impedance matching problems, and can be efficiently and stably manufactured.

### DESCRIPTION OF THE PRIOR ART

Due to diversity of manufacturing technology of different manufacturers, network connectors manufactured are often of difference in the final products thereof, but still in compliance with the standards and requirements of communication protocol issued by related associations and communities, such as IEEE (Institute of Electrical and Electronics Engineers) and EMI (Electro-Magnetic Interference). To improve performance and obtain enhanced effect, all manufacturers are devoted themselves to the research and improvement of network connector and makes trials on various combinations of different electronic components, while keeping stick to the communication protocols, in an attempt to manufacture products having excellent performance.

A known network connector adopts an arrangement of connecting a plurality of signal transformers in cascade to provide the desired conditions of operation. However, when sold to users or manufactured, the signal transformers each show individual electrical characteristics (due to being affected by various factors, including density of wire wrapping, varying thickness of wires, or more detailedly the content of copper in the wires), so that a manually conducted fine adjustment is necessary for the manufacture of the network connector. This leads to a loss of manufacturing time and may further cause issues of matching and electromagnetic interference (due to wire stretching being varying in the manufacture that affect the EMI characteristics thereof). An apparent influence may thus be imposed on the speed and quality of transmission of information in networks.

Thus, it is desired, for the inventor and the manufacturers of the business, to provide a solution that helps overcome the above discussed problems and shortcomings.

### SUMMARY OF THE INVENTION

In view of the above problems, the present invention aims to a structure of a printed circuit board of an electrical connector that shows excellent IEEE and EMI properties, has no impedance matching problem, and can be efficiently and stably manufactured.

The primary object of the present invention is to provide a technical feature that uses circuit boards to serve as bridge connection in order to allow the circuit boards to be assembled to coupling modules in such a way that additional wiring is not needed and connection can be established through soldering applied to arrayed pins, thereby achieving the advantages that assembling can be carried out in an easy, fast, and time-efficient manner.

A structure that achieves the above object comprises a plurality of circuit boards, which provides a network signal transmission matching function and a plurality of coupling modules, which comprises arrayed pins embedded therein, wherein each of the circuit boards is fixedly mounted to one side of each of the coupling modules and is electrically connected to ends of the arrayed pins and forms a channel.

With the above technique, the problems of the conventional network connectors that the manufacture time is long and issues of matching and electromagnetic interference may easily occur can be overcome to achieve the useful advantages of the present invention as discussed above.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is an exploded view of the preferred embodiment of the present invention.

FIG. 3 is a schematic view showing a portion of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

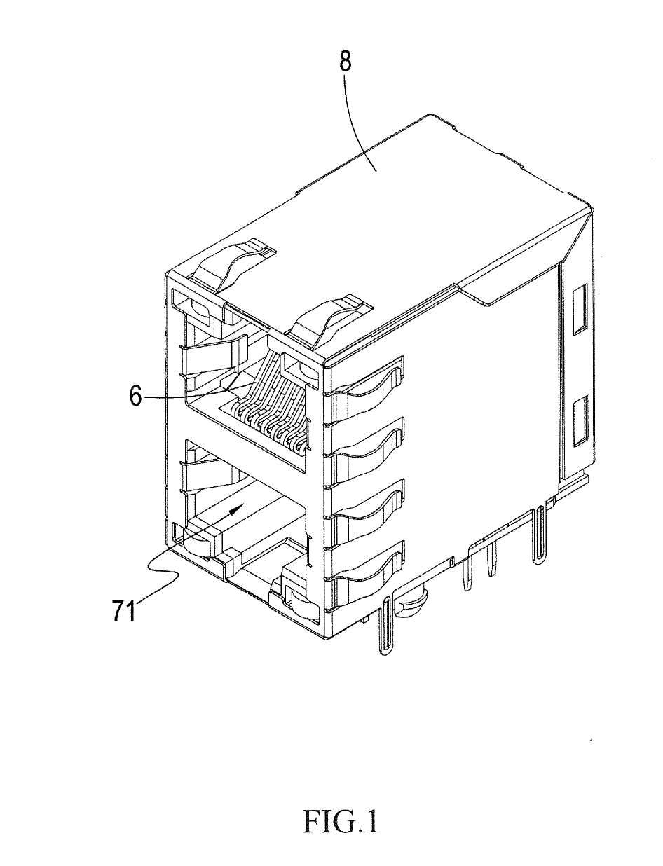

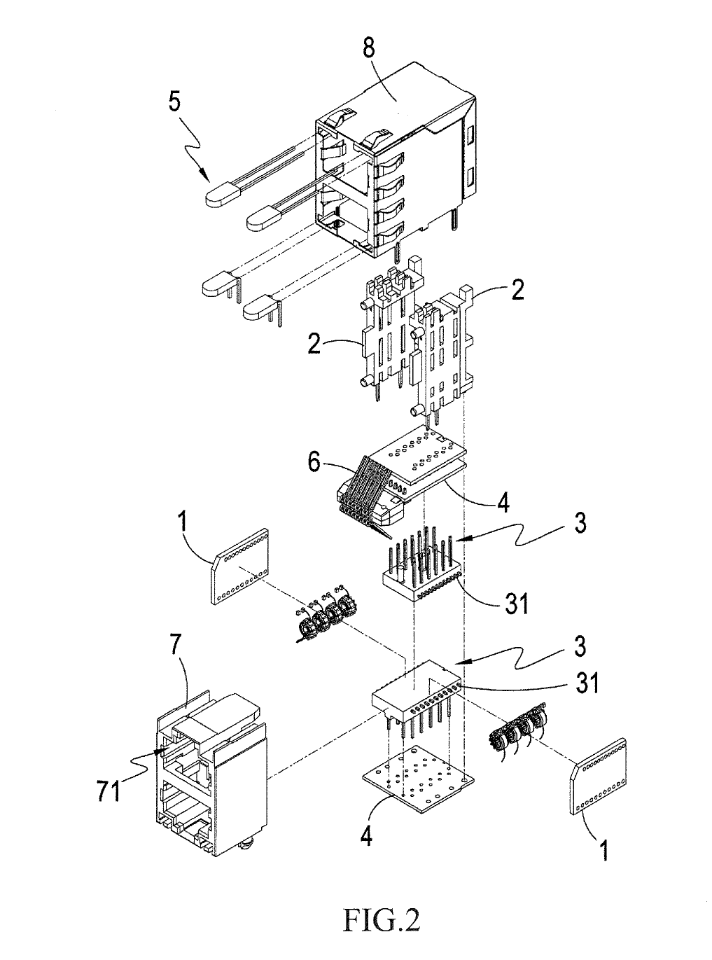

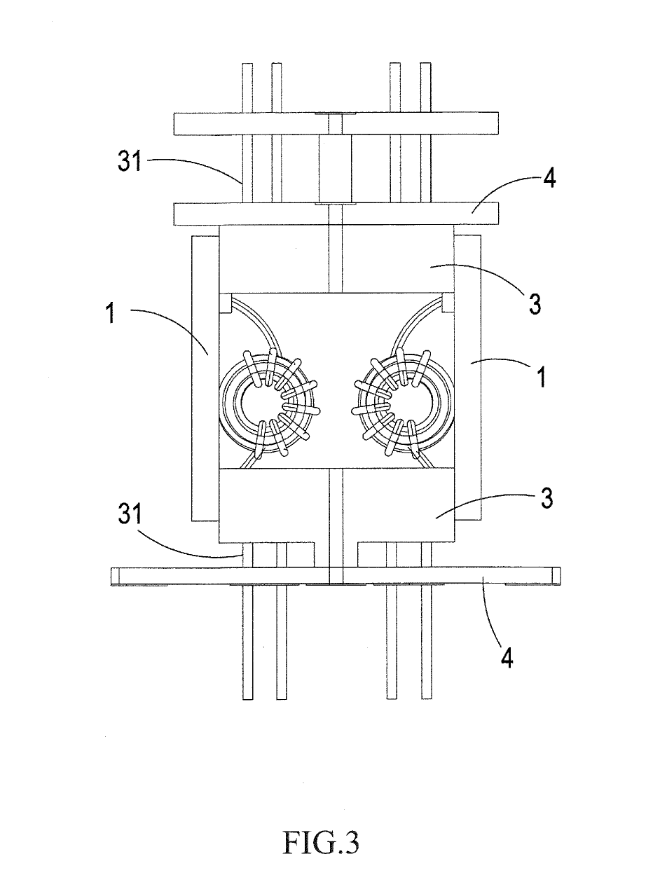

Referring to FIGS. 1-3, which are respectively a perspective view and an exploded view of a preferred embodiment of the present invention, and a schematic view showing a portion of the preferred embodiment of the present invention, these drawings clearly show that the present invention comprises:

a plurality of circuit boards 1, which provides a network signal transmission matching function and is each a printed circuit board, wherein the circuit boards 1 are each provided, at least at one side thereof, with at least an isolation board 2;

a plurality of coupling modules 3, which comprises L-shaped arrayed pins 31 embedded therein and is arranged as upper and lower levels, wherein each of the circuit boards 1 is fixedly mounted to one side of each of the coupling modules 3 and is electrically connected to ends of the arrayed pins 31 and forms a channel;

at least one circuit substrate 4, which is electrically connected to opposite ends of the arrayed pins 31, wherein the circuit substrate 4 is electrically connected to at least one light-emitting module 5;

at least a golden finger module 6, which is electrically connected to the circuit substrate 4, wherein the golden finger module 6 is partially received in at least an insulation body 7, the insulation body 7 forming at least an insertion opening 71 that exposes partially the golden finger module 6; and

a shielding shell 8, which receives the insulation body 7 therein.

As such, to assemble, the coupling modules 3 are first arranged to juxtapose each other and two sides thereof are respectively soldered and connected to the circuit boards 1 by means of the arrayed pins 31, whereby they surround and collectively define therebetween a channel. Then, the circuit substrates 4 are soldered and mounted to the arrayed pins 31 so as to also connect the golden finger modules 6. Afterwards, the isolation boards 2, the light-emitting modules 5, and the insulation bodies 7 are assembled. Finally, these components are collectively placed into the shielding shell 8. Thus, such an assembling process can effectively increase the efficiency of manufacture and save cost.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of printed circuit board of electrical connector, the electrical connector having a main structure comprising:
a plurality of circuit boards, which provides a network signal transmission matching function; and
a plurality of coupling modules, which comprises arrayed pins embedded therein, wherein each of the circuit boards is fixedly mounted to one side of each of the coupling modules and is electrically connected to ends of the arrayed pins and forms a channel.

2. The structure of printed circuit board of electrical connector according to claim 1, wherein the pins are of an L-shaped configuration.

3. The structure of printed circuit board of electrical connector according to claim 1, wherein the coupling modules are arranged as upper and lower levels.

4. The structure of printed circuit board of electrical connector connector according to claim 1, wherein the arrayed pins have opposite ends that are electrically connected to at least a circuit substrate.

5. The structure of printed circuit board of electrical connector according to claim 4, wherein the circuit substrate is electrically connected to at least a golden finger module, which is partially received in at least an insulation body, the insulation body forming at least an insertion opening that exposes partially the golden finger module.

6. The structure of printed circuit board of electrical connector according to claim 5, wherein the insulation body is received in a shielding shell.

7. The structure of printed circuit board of electrical connector according to claim 4, wherein the circuit substrate is electrically connected to at least a light-emitting module.

8. The structure of printed circuit board of electrical connector according to claim 4, wherein the circuit board is provided, at least at one side thereof, with at least an isolation board. The structure of printed circuit board of electrical connector according to claim 1, wherein the circuit board is a printed circuit board.
